(19) United States
(12) Patent Application Publication
(10) Pub. No.: US 2024/0234875 A9
(43) Pub. Date: Jul. 11, 2024

(54) On-Chip Solid-State Zn-Air Microbattery and Method of its Manufacture

(71) Applicant: Georg-August-Universität Göttingen Stiftung Öffentlichen Rechts, Göttingen (DE)

(72) Inventors: Hua Zhang, Göttingen (DE); Kai Zhang, Bovenden (DE); Minshen Zhu, Dresden (DE); Oliver G. Schmidt, Dresden (DE)

(21) Appl. No.: 18/533,746

(22) Filed: Dec. 8, 2023

Related U.S. Application Data
(63) Continuation of application No. PCT/EP2022/065713, filed on Jun. 9, 2022.

(30) Foreign Application Priority Data
Jun. 11, 2021 (DE) 10 2021 115 178.3

(51) Int. Cl. H01M 12/08; H01M 4/86; H01M 4/88; H01M 4/90; H01M 50/11; H01M 50/138

(52) U.S. Cl. CPC H01M 12/08; H01M 4/8673; H01M 4/8825; H01M 4/8896; H01M 4/9041; H01M 50/11; H01M 50/1385; H01M 2004/8689; H01M 2300/0085

(57) ABSTRACT

For manufacturing a Zn-air battery, a semi-liquid hydrogel including a polymer component comprising an irradiation activatable crosslinking initiator, and including an electrolyte component is deposited on a zinc anode. At least parts of the semi-liquid hydrogel are irradiated to activate the irradiation activatable crosslinking initiator for crosslinking the polymer component such as to transform the semi-liquid hydrogel into a drop-free yet sticky hydrogel. An air cathode is stuck to the drop-free yet sticky hydrogel.

### CROSS REFERENCE TO RELATED APPLICATIONS

This application is a continuation to international application PCT/EP2022/065713 entitled “On-Chip Solid-State Zn-Air Microbattery and Method of its Manufacture”, filed Jun. 6, 2022 and claiming priority to German patent application DE 10 2021 115 178.3 also entitled “On-Chip Solid-State Zn-Air Microbattery and Method of its Manufacture” and filed on Jun. 11, 2021.

### FIELD OF THE INVENTION

The present invention relates to a method of manufacturing a Zn-air battery and to a Zn-air battery which may be manufactured according to this method.

More particularly, the present invention relates to a method of manufacturing a Zn-air battery which is suitable for being implemented as an on-chip microfabrication process, and to a Zn-air battery which is suitable for being implemented as an on-chip device.

### BACKGROUND OF THE INVENTION

Generally, a Zn-air battery consists of a zinc anode and an air electrode on opposite sides of an electrolyte and a separator arranged between them. With a gelled electrolyte, there is no need for an additional separator between the zinc anode and the air cathode.

B.-Q. Li et al.: “A porphyrin covalent organic framework cathode for flexible Zn-air batteries”, Energy Environ. Sci., 2018, 11, 1723 disclose flexible and aqueous Zn-air batteries in which a porphyrin covalent organic framework (POF) with cobalt ions coordinated within the porphyrin units is used as a cathode electrocatalyst. Carbon nanotubes (CNTs) serve as scaffolds for morphology regulation. The CNT@POF hybrid is interwoven into a free-standing and flexible film, and arranged as an air cathode on a gel solid electrolyte. On the opposite side of the gel solid electrolyte, a zinc foil is arranged as an anode. The gel solid electrolyte is an alkaline polyvinyl alcohol gel. Pressed nickel foams are arranged as current collectors on the outer sides of both the air cathode and the zinc anode. This design is not suitable for an on-chip microfabrication.

P. Gu et al.: “Rechargeable zinc-air batteries: a promising way to green energy”, J. Mater. Chem. A, March 2017, DOI: 10.1039/c7ta01693j, report the research progress on different components of zinc-air batteries. Particularly, they report air electrode designs and bifunctional catalysts for rechargeable zinc-air batteries. With regard to the electrolyte, P. Gu et al. point out that gelling is a possible solution to minimize water loss and enhance battery performance and life. More particular, P. Gu et al. report a fiber-shape flexible, stretchable and rechargeable battery with a hydrogel polymer electrolyte made of 8.3 wt % PVA, 0.83 wt % PEO and 8.3 wt % KOH arranged between a zinc string and an RuO₂-carbon nanotube (CNT) electrocatalyst loaded air cathode. Cross-stacked and porous CNT sheets behaved as a gas diffusion layer and a current collector with good oxygen reduction reaction (ORR) catalytic properties. The cross-linked electrolyte showed good mechanical properties and a high ionic conductivity. This design is also not suitable for an on-chip microfabrication.

M. Hilder et al.: “Paper-based, printed zinc-air battery”, Journal of Power Sources, Volume 194, Issue 2, 1 Dec. 2009, pages 1135-1141, disclose a flexible battery printed on paper by screen-printing a zinc/carbon/polymer composite anode on one side of the sheet, polymerizing a poly(3,4-ethylenedioxythiophene) (PEDOT) cathode on the other side of the sheet, and applying a lithium chloride electrolyte between the two electrodes. The PEDOT cathode is prepared by inkjet printing a pattern of iron(III)p-toluenesulfonate as a solution in butan-1-ol onto paper, followed by vapor phase polymerization of the monomer. The electrolyte is prepared as a solution of lithium chloride and lithium hydroxide and also applied by inkjet printing onto paper, where it is absorbed into the sheet cross-section. The authors report that the paper/electrolyte combination has a limited ability to take up anode oxidation products before suffering a reduction in ionic mobility.

T. Ma and J. D. MacKenzie: “Fully Printed, High Energy Density Flexible Zinc-Air Batteries Based on Solid Polymer Electrolytes and a Hierarchical Catalyst Current Collector”, Flex. Print. Electron. 4, 015010, 2019, disclose a zinc-air electrode with a printed cell stack utilizing a printable solid polymer electrolyte based on a non-volatile hydroxide anion ionic liquid and a printed porous hierarchically-structured catalyst layer. The catalyst layer is composed of a porous carbon nanotube cathode current collector network supporting a nanoscale MnCo₂O₄-decorated reduced graphene oxide air catalyst.

International application publication WO 2017/171648 A1 discloses an electrochemical cell and a method of making the same. The electrochemical cell comprises an anode structure comprising Zinc, a cathode structure comprising a catalyst, and a hydrogel located between the anode structure and the cathode structure. The catalyst may be CoOx/C, and the hydrogel may be a free-standing alkaline polyacrylamide hydrogel which was first synthesized via UV-initiated radical polymerization of acrylamides, followed by exchange of water with an alkaline electrolyte of potassium hydroxide (KOH).

United States patent application publication US 2020/0119316 A9 discloses a flexible micro-battery comprising an anode current collector, a cathode current collector, an anode extending along an arcuate path, a generally planar cathode extending along the arcuate path, wherein the anode is positioned above the cathode, a separator positioned between the anode and the cathode, wherein the separator extends along the arcuate path, an electrolyte positioned generally surrounding the anode, the cathode and the separator to provide ionic conductivity between the anode and the cathode, a flexible packaging generally surrounding the anode, the cathode, the cathode current collector, the separator and the electrolyte, an encapsulating copper layer surrounding the flexible packaging, and a hydrogel layer. The hydrogel layer stores water. The water of the hydrogel layer may diffuse to the cathode and separator layers within the battery.

There still is a need of a method of manufacturing a Zn-air battery which is suitable for an on-chip microfabrication and results in high energy density Zn-air batteries, and a high energy density micro Zn-air battery which can be manufactured directly on a chip.

### SUMMARY OF THE INVENTION

The present invention relates to a method of manufacturing a Zn-air battery. The method comprises depositing a zinc anode on a substrate. The substrate is a silicon chip or a PCB. The method further comprises depositing a semi-liquid hydrogel on the zinc anode. The semi-liquid hydrogel includes a polymer component comprising an irradiation-activatable crosslinking initiator, and an electrolyte component. The method further comprises irradiating at least parts of the semi-liquid hydrogel to activate the irradiation-activatable crosslinking initiator for crosslinking the polymer component such as transforming the semi-liquid hydrogel into a drop-free yet sticky hydrogel, and sticking an air cathode to the drop-free yet sticky hydrogel.

Further, the present invention relates to a Zn-air battery. The Zn-air battery comprises a zinc anode deposited on a substrate, a layer of a drop-free hydrogel on the zinc anode, and an air cathode sticking to the drop-free hydrogel. The substrate is a silicon chip or a PCB. The drop-free hydrogel includes a polymer, that is crosslinked on-site and comprises an irradiation-activatable crosslinking initiator, and an electrolyte. The air cathode comprises electrically conductive carbon, a covalent organic framework and a catalyst.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components of the drawings are not necessarily to scale, emphasize instead being placed upon clearly illustrating the principles of the present invention. In the drawings, like reference numerals designate corresponding parts throughout the several views.

FIG. 1A to FIG. 1D shows the design of a micro Zn-air battery and illustrates an on-chip integration of a hydrogel electrolyte and a carbon nanotube air cathode in an embodiment of a method of manufacturing a micro Zn-air battery on a chip.

FIG. 2A to FIG. 2C schematically illustrate a further embodiment of the method of manufacturing a micro Zn-air battery on a chip.

FIG. 3A to FIG. 3F schematically illustrate more details of the method according to FIG. 2 and depict steps of etching a silicon wafer, Au deposition, Zn deposition, electrolyte coating, and adding an air cathode material.

### DETAILED DESCRIPTION

A method of manufacturing a Zn-air battery comprises depositing semi-liquid hydrogel, which includes a polymer component comprising an irradiation-activatable crosslinking initiator and which further includes an electrolyte component, on a zinc anode. At least parts of the semi-liquid hydrogel are irradiated to induce crosslinking of the polymer component. Particularly, the irradiation is used to activate the crosslinking initiator for crosslinking the polymer component such as to transform the semi-liquid hydrogel into a drop-free yet sticky hydrogel. The term “drop-free yet sticky” indicates that the hydrogel with the crosslinked polymer component has at least such a spatial stability that it will not form drops due to surface tensions or gravity or other external forces exerted on the hydrogel during the further steps of manufacturing the Zn-air battery and the subsequent use of the Zn-air battery. More particular, the drop-free hydrogel may be spatially stable to such an extent that it will not form drops in any orientation of the hydrogel deposited with regard to the vertical within a certain period of time of at least one minute. However, even after crosslinking the polymer component, the hydrogel is still sticky. This is important for the next step of the method, i.e. for sticking an air cathode to the drop-free yet sticky hydrogel. In this step, the air cathode is fixed to the hydrogel due to the stickiness of the hydrogel. Further, the air cathode will be partially impregnated with the electrolyte component of the hydrogel. All in all, the crosslinking of the polymer component due to irradiating the hydrogel is sufficient to spatially stabilize the hydrogel but it leaves sufficient reactivity of the polymer component or stickiness of the hydrogel for fixing the air cathode in the step of sticking the air cathode to the drop-free yet sticky hydrogel.

Prior to depositing the semi-liquid hydrogel, the zinc anode may be deposited on a substrate. This deposition of the zinc anode may be implemented by electrodeposition or microlithography. Both techniques are well known to those skilled in the art and suitable for microfabrication. In any case, a rather massive or 3D zinc anode will be deposited on the substrate as the zinc of the zinc anode will partially be dissolved in operating the Zn-air battery. Generally, the method may also be used for manufacturing the Zn-air battery on a zinc foil or the like. However, the method is particularly well suited for manufacturing the Zn-air battery on a substrate like a chip or PCB on which further devices may be manufactured or provided otherwise.

Prior to depositing the zinc anode, a current collector may be deposited on the substrate so that the zinc anode will be deposited on top of the current collector. The current collector may, for example serve for electrically connecting a plurality of separate partial anodes of the zinc anode, which may be arranged side by side on the substrate. In the Zn-air battery built on a chip or PCB, the current collector may be part of the conductor path system provided on the chip or PCB. In one embodiment, the current collector is deposited on the PCB by sputtering an electrically conductive metal, like, for example, gold onto the substrate. More particularly, the current collector may consist of about 10 nm chromium and some 10 nm gold deposited on top of the chromium using magnetron sputtering.

In one embodiment of the method of manufacturing a Zn-air battery, the semi-liquid hydrogel is used as a “negative photoresist” in the steps of depositing the semi-liquid hydrogel and irradiating the semi-liquid hydrogel. In this embodiment, the semi-liquid hydrogel is a soluble semi-liquid hydrogel and deposited over an area of the respective substrate extending beyond the zinc anode and a desired cross-section of the Zn-air battery to be manufactured. Then, the semi-liquid hydrogel is irradiated to induce crosslinking of the polymer component for transforming the soluble semi-liquid hydrogel into a non-soluble hydrogel in that parts of the semi-liquid hydrogel that are irradiated. In this embodiment, the method comprises the further step of dissolving the still soluble semi-liquid hydrogel outside of the irradiated parts in a suitable solvent and removing the solvent and the dissolved hydrogel from the substrate. This additional step may also be designated as developing a layer of the hydrogel for removing the unwanted, i.e. the non-irradiated parts of the layer. Whereas a standard positive photoresist will be transformed by irradiation into a soluble state to be removed from a substrate, the polymer component of the hydrogel will be irradiated to be transformed into a non-soluble state to make the hydrogel non-soluble so that the irradiated hydrogel is not removed in developing the hydrogel layer. Thus, the semi-liquid hydrogel may be designated as a “negative photoresist”.

Typically, the semi-liquid hydrogel will be irradiated with electro-magnetic irradiation, preferably with light, more preferably with UV light to induce the crosslinking of its polymer component. The dose of the irradiation is chosen in such a way, that the polymer component is sufficiently crosslinked to form a drop-free hydrogel. The dose of the irradiation may, for example, be in a range of 10 J/cm² to 50 J/cm². Lower or higher doses may also be applied, e.g., if the efficiency of the crosslinking is sufficiently effective or if the crosslinking is supposed to be performed very fast. The above indicated dose of the irradiation is related to the surface area of the parts of the hydrogel irradiated. With regard to the mass of the semi-liquid hydrogel irradiated, the dose of the irradiation will typically be in a range from 100 J/g to 500 J/g.

In another embodiment of the method of manufacturing a Zn-air battery, the steps of depositing the semi-liquid hydrogel and irradiating the semi-liquid hydrogel include 3D-printing or jet modeling the semi-liquid hydrogel, and irradiating the entire layer of the semi-liquid hydrogel simultaneously and/or irradiating each or some of a plurality of portions of the semi-liquid hydrogel, that are arranged on the zinc anode one after the other, directly after their arrangement on the zinc anode. Depositing the semi-liquid hydrogel by 3D-printing or jet modeling may allow for only applying the hydrogel there, where it is actually needed, i.e. over the desired cross section of the Zn-air battery to be manufactured, and to do without removing parts of the hydrogel deposited. Nevertheless, the semi-liquid hydrogel is irradiated for crosslinking its polymer component. The semi-liquid hydrogel may be irradiated after all hydrogel has been deposited on the zinc anode and/or already during depositing the hydrogel on the zinc anode. Further, the intensity distribution of the irradiation over the deposited semi-liquid hydrogel may be homogenous or not. For example, the hydrogel may be irradiated at high intensities of the irradiation at the lateral border of the deposited hydrogel as compared to a central area of the deposited hydrogel. Once again, the semi-liquid hydrogel is typically irradiated with UV light. With regard to the mass of the semi-liquid hydrogel irradiated, the dose of the irradiation may be in a range from 100 J/g to 500 J/g.

In all embodiments of the method of manufacturing a Zn-air battery, the parts of the deposited semi-liquid hydrogel irradiated may be selected by using a mask arranged between an irradiation source and the deposited semi-liquid hydrogel and/or by focusing the irradiation to the respective part of the deposited semi-liquid hydrogel or by scanning the respective parts of the deposited semi-liquid hydrogel with the focused irradiation. Those skilled in the art will be aware of various options available for selectively irradiating parts of the semi-liquid hydrogel. This particularly applies with regard to light being used for irradiating the semi-liquid hydrogel

The step of sticking the air cathode to the drop-free yet sticky hydrogel may include forming a film of air cathode material and pressing the film of the air cathode material and the drop-free yet sticky hydrogel together. In one practical implementation, the drop-free yet sticky hydrogel may be pressed from above on the film of the air cathode material arranged on a support. Further, the film of the air cathode material may be carved to size afterwards, i.e. once the air cathode material sticks to the hydrogel. The term “film” as used here shall include the meanings of the terms “foil” and “sheet”.

The method of manufacturing a Zn-air battery may further comprise laterally enclosing the zinc anode, the hydrogel and the air cathode by an electrically isolating border cover frame. This border cover frame will further mechanically stabilize the Zn-air battery manufactured. It may also be used for electrically contacting the air cathode to a conductor path on the substrate by an electric conductor arranged in or on the border cover frame.

A Zn-air battery according to the present disclosure comprises a zinc anode, a layer of a drop-free hydrogel on the zinc anode, the hydrogel including a polymer, that is crosslinked on-site and comprises an irradiation-activatable crosslinking initiator and an electrolyte, and an air cathode sticking to the hydrogel. The irradiation-activatable crosslinking initiator may be a so called photoinitiator.

The details of the zinc anode, the polymer and the air cathode of the Zn-air battery according to the present disclosure which are provided in the following also apply to the method according to the present disclosure.

The polymer may further comprise a crosslinker. More particularly, the crosslinker may include N, N′-methylenebisacrylamide. The irradiation-activatable crosslinking initiator may particularly include α-ketoglutaric acid. Commercial photoinitiators, like, for example, Irgacure 2959 and Irgacure 651 may also be used.

The polymer may include at least one component selected from polyvinyl alcohols, polyacrylic amides, polyacrylic acids, sodium polyacrylates and potassium polyacrylates. Preferably, the polymer includes a polyvinyl alcohol/polyacrylic acid composite.

The electrolyte may include any alkaline or non-alkaline electrolyte suitable for use in Zn-air electrodes as part of the hydrogel. Preferably, the electrolyte includes an OH⁻-Donor.

In a preferred embodiment, the hydrogel includes 25 wt % to 30 wt % acrylic acid, 2 wt % to 3 wt % polyvinyl alcohol, 0.1 wt % to 0.3 wt % N, N′-methylenebisacrylamide, 0.3 wt % to 0.5 wt % α-ketoglutaric acid, and 15 wt % to 20 wt % NaOH.

In a more preferred embodiment, the hydrogel includes 27 wt % to 28 wt % acrylic acid, 2.4 wt % to 2.6 wt % polyvinyl alcohol, 0.15 wt % to 0.25 wt % N, N′-methylenebisacrylamide, 0.35 wt % to 0.45 wt % α-ketoglutaric acid, and 17 wt % to 18 wt % NaOH.

In the most preferred embodiment, the hydrogel includes 27.5 wt % acrylic acid, 2.5 wt % polyvinyl alcohol, 0.2 wt % N, N′-methylenebisacrylamide, 0.4 wt % α-ketoglutaric acid, and 17.5 wt % NaOH.

The respective rest part of the hydrogel may at least essentially be water. The rest part may also include additives. Further, the NaOH may, at least partially, be replaced by some other alkali hydroxide or by another source of OH⁻ anions.

This composition of the hydrogel proved to be very advantageous both with regard to its usability in manufacturing the Zn-air battery and to the electrical and mechanical properties of the Zn-air battery.

The air cathode preferably comprises electrically conductive carbon, a covalent organic framework and a catalyst, preferably CNTs and/or porphyrin and/or cobalt. Most preferably, the air cathode is a CoPOF@CNT hybrid. However, the present disclosure is not limited to air cathodes of this particular composition. The cathode may, for example, be alternatively based on CNTs and comprise Pt or Ir as a catalyst. Further, the cobalt in the CoPOF@CNT can be replaced by Ni, Fe and/or Mn.

The zinc anode of the Zn-air battery may be deposited on a substrate and connected to a current collector formed on the substrate. The zinc anode typically is a rather massive or 3D zinc anode. It may be a zinc anode of a uniform thickness over its lateral extension. Alternatively, the zinc anode may consist of plurality of separate zinc sources arranged in holes or depressions within the substrate and interconnected by the current collector. The electrolyte may also extend into these holes or depressions. Alternatively, the hydrogel is provided in a layer of uniform thickness between the substrate and the air cathode.

The zinc anode, the hydrogel and the air-cathode may be laterally enclosed by an electrically isolating border cover frame. The air cathode may be electrically contacted to a conductor path formed on the substrate by an electric conductor arranged in or on the border cover frame.

Lateral dimensions of the zinc anode, the layer of the drop-free hydrogel and the air cathode of the Zn-air battery are generally in a range from 0.5 to 50 mm. Preferably they are in a range from 1 to 10 mm and more preferably in a range from 1.5 to 2 mm. A stack thickness of the zinc anode, the layer of the drop-free hydrogel and the air cathode is generally in a range from 1 to 20 mm, preferably in a range from 1 to 6 mm and more preferably in a range from 1.2 to 2 mm. With the preferred dimensions, the Zn-air battery is rather small.

The substrate on which a Zn-air battery sits is a silicon chip or PCB. Preferably, at least one other device is mounted to this silicon chip or PCB. Most preferably, this other device is electrically connected to the Zn-air battery.

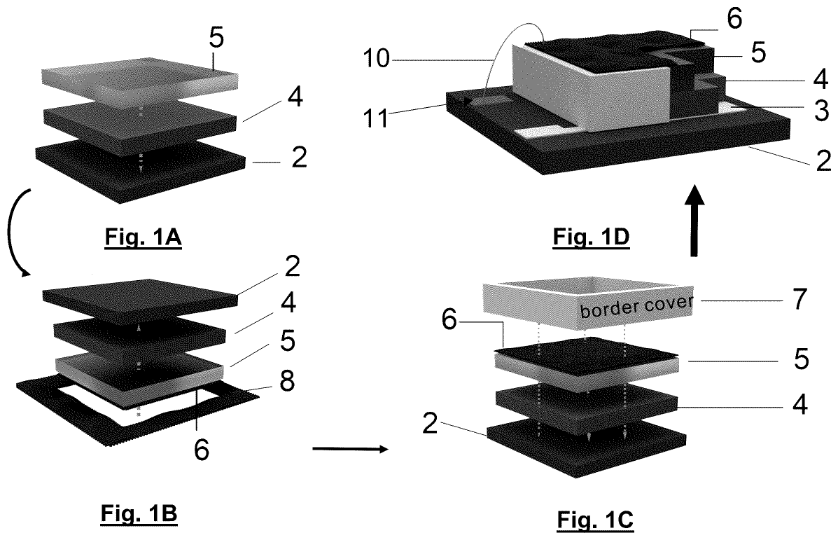

Now referring in greater detail to the drawings, the micro Zn-air battery 1 according to FIG. 1D is arranged on a chip 2 and comprises a current collector 3 on the chip 2, a zinc anode 4 on the current collector 3, a hydrogel 5 on the zinc anode 4, an air cathode 6 on the hydrogel 5 and a border cover frame 7 enclosing the zinc anode 4, the hydrogel 5 and the air cathode 6 on the chip 2. An electric conductor 10 connects the air cathode 6 to a conductor path 11 on the chip 2. The hydrogel 5 includes both a polymer component serving as a separator and an electrolyte component.

In the method of manufacturing the Zn-air battery also illustrated in FIG. 1, the hydrogel 5 is coated as a semi-liquid hydrogel and patterned on the chip 2, see FIG. 1A. More particularly, a 2×2 mm² layer of the hydrogel 5 is formed on the chip 2 of 10×10 mm². After that, the chip 2 is flipped over and imprinted or pressed onto a carvable air cathode material 8, see FIG. 1B. The position and dimension of the air cathode 6 match the patternable hydrogel 5. The construction process is finished by flipping the chip 2 over again and sealing the peripheral borders to improve the liquid electrolyte retention in the hydrogel 5 by means of the border cover frame 7, see FIG. 1C.

The rechargeability of the Zn-air battery 1 relies on the bifunctional air cathode 6 with the ability to generate and reduce oxygen. The carvable air cathode material 8 needs to be porous, electrically conductive, and highly active in catalyzing oxygen redox reactions. A porous freestanding film interwoven with carbon nanotubes (CNTs) can be torn apart and therefore is a good air cathode material and a good host for catalytic materials used for the Zn-air battery 1. In terms of catalysts, the high cost and low durability of precious metal catalysts have hampered their broad application. Covalent organic frameworks (COFs), where molecular building units are connected to form a periodic network, are programmable with catalytic functionalities and highly stable due to the strong covalent bonding. The COFs are also porous for efficient gas permeability and ion conduction, thus facilitating the oxygen redox reaction at the solid-liquid-gas interface. Moreover, the COFs can grow on CNT hosts via intermolecular π-π interactions and create a hybrid one-dimensional material. All these features give rise to COFs with catalytic properties more remarkable than the simple mixture of catalytic and conductive host materials.

The method of manufacturing summarized above and a high-performance carvable air cathode material 8 for an on-chip Zn-air rechargeable micro-size battery 1 (μZAB) may be combined. For this purpose, cobalt (Co) catalytic units are blended with a porphyrin organic covalent framework (POF), and then the Co-embedded POF (CoPOF) is hybridized with CNTs. The catalytic activity of the CoPOF is optimized by controlling the C—N coordination and the valence of the Co units. A two-step filtration process may be applied to produce the carvable air cathode with a CNT-based gas diffusion layer (GDL), delivering a high peak power density of 89 mW cm⁻² and a stable cycling performance for 110 cycles (corresponding to 110 hours) in a hydrogel (polyvinyl alcohol networking with polyacrylic acid, PVA-co-PAA). The on-chip Zn-air microbattery (μZAB) demonstrates a high volumetric power density of 570 mW cm⁻³ and record-high volumetric energy density of 413 Wh L⁻¹, which are about 3 times the commercial compact primary ZAB (162 mW cm⁻³ and 130 Wh L⁻¹). The lifecycle capacity of the on-chip μZAB reaches 4.5 mAh, about twice the smallest on-chip lithium ion battery available in the market. it could also be demonstrated that the μZAB can drive electronic devices projecting various application scenarios and is wirelessly rechargeable to prolong the life time.

The CoPOF@CNT catalyst is then assembled into a carvable air cathode material 8 for quasi-solid-state Zn-air batteries. A general method to fabricate an air cathode is to combine a catalyst slurry with a hydrophobic porous membrane permeable to air, forming a two-layer structure. The air-permeable membrane is regarded as a gas diffusion layer (GDL) to facilitate the oxygen exchange at the gas-solid-liquid phase. To mimic this structure, a two-step filtration procedure has been developed. A CNT GDL is first filtrated and forms a porous membrane. Subsequently, the CoPOF@CNT catalysts are filtrated to establish a porous catalyst layer. The CNT GDL shows a more open structure than the catalyst layer and produces more channels accessible for air. The as-fabricated freestanding air cathode is robust under mechanical deformations after being peeled off from the filter paper. Considering the intrinsic mechanical flexibility and abundant internal gas channels, the as-fabricated freestanding CoPOF@CNT film with the GDL (termed as w/GDL) served directly as the air cathode 6 without a separate current collector on top. The mass loading of the catalyst for the freestanding air cathode is about 2.0 mg cm⁻². The peak power density with the CNT GDL increases by 18% compared to the one without the GDL (termed as w/o GDL). Such a high power density of 89 mW cm⁻² outperforms reported freestanding air cathodes. It is noteworthy that a 35% increment of the peak power density is attainable by using the CoPOF@CNT catalyst rather than simple mixtures of the CNTs and the Pt/C+Ir/C catalyst with the same mass loading in a freestanding air cathode. The substantial improvement demonstrates the advantages of the molecular-level engineering catalytic units into a stable framework and the combination with the conductive material by the intermolecular bonding. The GDL improves the cycling stability by 50%. The energy efficiency is also stable. The round-trip efficiency is still at 56.6% after 100 cycles. By contrast, the energy efficiency quickly drops to 48% for the freestanding cathode without the GDL.

### Synthesis and Manufacturing Example

Synthesis of CoPOF@CNTs.

A mixture of CNT (50 mg), 100 mL of acetic acid, and 50 μL of trifluoroacetic acid was ultrasonicated for 60 min to form a homogenous suspension. After that, reagents including pyrrole (18.2 μL), nitrobenzene (0.90 mL), BDA (17.4 mg), and cobalt acetate (24.9 mg) were added into the suspension and ultrasonicated for another 30 min. The final mixture was transformed into a three-neck round-bottom flask and kept at the desired temperature (80° C., 100° C., and 120° C.) for 24 h under magnetic stirring and reflux. Finally, the as-obtained product was filtrated, washed with deionized water and ethanol several times, and dried at 60° C. overnight.

Fabrication of CoPOF@CNT Air Cathodes.

CoPOF@CNT catalysts (10 mg) and Nafion solution (5.0 wt. %, 100 μL) were dispersed in isopropanol (1.9 mL) and ultrasonicated for 30 min to form a homogenous catalyst ink. The catalyst ink (1 mL) was coated onto carbon cloth via a drop-casting method and vacuum-dried overnight. Pt/C (20 wt. %, 5 mg) and WC (20 wt. %, 5 mg) are mixed together to prepare Pt/C+Ir/C air cathodes instead of 10 mg of CoPOF@CNT catalyst. The areal mass loading of the catalyst is controlled at 1.15 mg cm⁻².

Fabrication of Carvable CoPOF@CNT Air Cathodes.

The freestanding CoPOF@CNT electrodes were fabricated via a two-step vacuum filtration method. First, CNT suspension (2 mg mL⁻¹, 20 mL) was vacuum-filtrated. Subsequently, the homogenous catalyst suspension (8 mg CoPOF@CNT or Pt/C+Ir/C in 20 mL isopropanol) was filtrated. The as-obtained membrane with a two-layer structure was then vacuum-dried at 60° C. overnight and peeled from the nitrocellulose membrane. The air cathode without GDL is fabricated by one-step filtration. The mass loading of the catalyst in all freestanding cathodes is about 2.0 mg cm⁻².

Synthesis of the Hydrogel Electrolyte.

NaOH (20 M, 0.8 mL) solution was slowly added into acrylic acid (1 mL) under stirring in an ice bath to form a transparent suspension. Then, the obtained suspension was mixed with PVA (5.0 wt. %, 2 mL) under vigorous stirring, followed by the addition of 0.1 wt. % N, N′-methylenebisacrylamide as the crosslinker and α-ketoglutaric acid (0.1 g mL⁻¹, 100 μL) as a photoinitiator. Subsequently, the transparent suspension was purged with nitrogen gas for 30 min and then exposed to UV irradiation (365 nm) for 2 h to form PVA-co-PAA gel. Rechargeable aqueous Zn-air batteries were simply assembled using a polished zinc foil (0.5 mm thickness) as the anode, 6 M aqueous KOH solution as the electrolyte, and a carbon cloth coated with CoPOF@CNT catalyst as the air cathode, respectively.

Fabrication of the On-Chip μZAB.

Silicon wafers were etched by reactive ion etching (RIE) (Plasma Lab 100; Oxford Instruments PLC, Abingdon, UK). Before etching process, SU8-10 with 20 μm in thickness was spin-coated on the silicon wafer, followed by baking at 65° C. for 3 min and 95° C. for 5 min. The patterning process was then performed using a maskless aligner (MLA 100, Heidelberg Instruments Mikrotechnik GmbH, Heidelberg, Germany). The patterned sample was baked at 95° C. and 150° C., respectively. The etching depth is controlled to be 60 μm. The current collector of 10 nm Cr and 50 nm Au were deposited using magnetron sputtering (nanoPVD-S10 A). A thick zinc film was electrodeposited on the surface of silicon arrays using a three-electrodes system, achieving a 3D zinc anode. Afterwards, the precursor solution of PVA-co-PAA was coated on the zinc layer and polymerized under UV light. Finally, the chip was flipped over and imprinted onto the carvable CoPOF@CNT film. Owing to the strong adhesion between CoPOF@CNT and PVA-co-PAA hydrogel, a small piece of the CoPOF@CNT film will be torn off and match the hydrogel dimension.

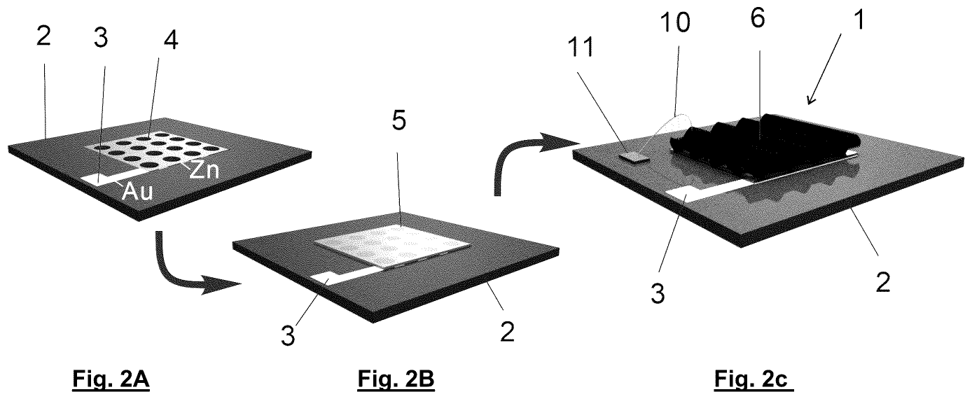

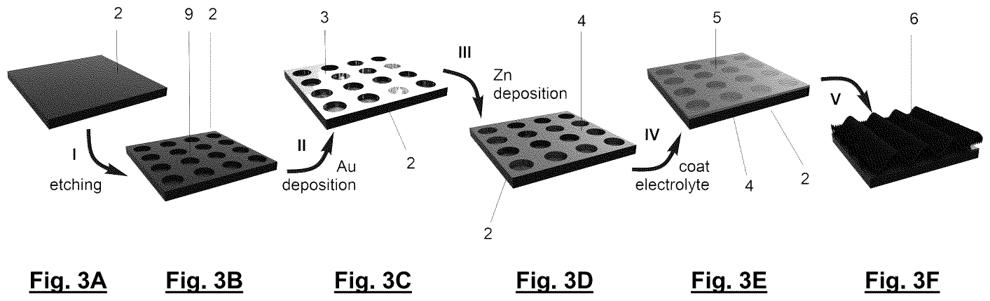

The on-chip Zn-air microbattery (μZAB) includes a Zn anode 4 engineered to a 3D microstructure on the chip 2, see FIG. 2A, to enlarge the interfacial contact between the hydrogel and the zinc anode 4, see FIG. 2B, to which the air cathode 6 is stuck, see FIG. 2C. The detailed process and corresponding digital images of each step are shown in FIGS. 3A to 3F. The 3D Zn anode has been reported to be efficient in improving the cycling stability. The silicon wafer, see FIG. 3A, is selectively etched, rendering a 3D structure with periodic holes 9 with a diameter of 200 μm and a depth of 60 μm, see FIG. 3B. Afterwards, a thin layer of gold (50 nm in thickness) is deposited as the current collector 3, see FIG. 3C. The zinc anode 4 is electrochemically deposited onto the gold layer, showing the morphology of nanosheets assembly, see FIG. 3D. PVA-co-PAA gel electrolyte of 1 mm thickness is then coated on the surface of zinc film using photopolymerization to provide the hydrogel 5, see FIG. 3E. Finally, the chip 2 may be flipped over and imprinted or pressed onto the carvable CoPOF@CNT film, see FIG. 3F (where the flipping is not shown). Owing to the strong adhesion of the PVA-co-PAA gel, the air cathode 6 can be firmly attached to the hydrogel 5 and separated from the residual parts of the air cathode material 8.

Results

After the on-chip fabrication, the μZAB can, for example, drive a digital watch right away. The as-fabricated μZAB measures a small footprint of 3×3 mm² including the border cover frame 7 and a total thickness of 1.5 mm. Note that the smallest commercial primary Zn-air battery has a form factor of 5.8 mm in diameter and 3.6 mm in height. The volume of the μZAB is about 9 times smaller than this compact Zn-air battery. The μZAB shows a high open-circuit voltage of 1.32 V. The μZAB delivers an ultrahigh volumetric power density of 570 mW cm⁻³, which is 3.5 times the commercial one (162 mW cm⁻³). At the device level, a record high value of 413 Wh L⁻¹ is attainable for the μZAB and is 3 times more than for the commercial one. The μZAB displays a long-term cycling stability at a large current density of 2 mA cm⁻². Owing to the excellent water retention performance of the PVA-co-PAA and protection by the border cover frame 7, stable performance lasting about 90 hours at a deep discharge depth of 35% (for Zn consumption) is attainable. The voltage gap is kept at a small value of 0.78 V, implying a high round-trip efficiency. Such a high round-trip efficiency is ascribed to the 3D Zn anode with a short diffusion pathway for electronic and ions. Furthermore, the cycling stabilities of the μZAB at various discharge depths demonstrate that the voltage gap raises with increasing the discharge depth. The lifetime capacity is estimated to be 4.5 mAh, which is about twice the lifetime capacity of commercially available lithium ion microbatteries.

Many variations and modifications may be made to the preferred embodiments of the invention without departing substantially from the spirit and principles of the invention. All such modifications and variations are intended to be included herein within the scope of the present invention, as defined by the following claims.

We claim:

1. A method of manufacturing a Zn-air battery comprising
depositing a zinc anode on a substrate, the substrate being a silicon chip or a PCB,
depositing a semi-liquid hydrogel on the zinc anode, the semi-liquid hydrogel including a polymer component comprising an irradiation-activatable crosslinking initiator, and an electrolyte component,
irradiating at least parts of the semi-liquid hydrogel to activate the irradiation-activatable crosslinking initiator for crosslinking the polymer component such as to transform the semi-liquid hydrogel into a drop-free yet sticky hydrogel, and
sticking an air cathode to the drop-free yet sticky hydrogel.

2. The method of claim 1, wherein the step of sticking the air cathode to the drop-free yet sticky hydrogel includes forming a film of air cathode material and pressing the film of the air cathode material and the drop-free yet sticky hydrogel together.

3. The method of claim 2, wherein the step of forming the film of air cathode material includes forming the film of electrically conductive carbon, a covalent organic framework and a catalyst, wherein the electrically conductive carbon comprises CNTs, the covalent organic framework comprises porphyrin, and the catalyst comprises cobalt.

4. The method of claim 2, wherein, wherein the drop-free yet sticky hydrogel is pressed from above on the film of the air cathode material arranged on a support.

5. The method of claim 2, wherein the film of the air cathode material is carved to size after pressing the film of the air cathode material and the drop-free yet sticky hydrogel together.

6. The method of claim 1, wherein the step of depositing the zinc anode on the substrate includes electrodeposition or microlithography.

7. The method of claim 1, further comprising, prior to depositing the zinc anode, depositing a current collector on the substrate.

8. The method of claim 7, wherein the step of depositing a current collector on the substrate includes sputtering electrically conductive metal.

9. The method of claim 1, wherein the steps of depositing the semi-liquid hydrogel and irradiating the semi-liquid hydrogel include
selecting the semi-liquid hydrogel from soluble semi-liquid hydrogels,
depositing the semi-liquid hydrogel over an area of the substrate extending beyond a desired cross-section of the Zn-air battery to be manufactured, and
irradiating the semi-liquid hydrogel to induce crosslinking of the polymer component for transforming the soluble semi-liquid hydrogel into a non-soluble hydrogel in selected parts of the soluble semi-liquid hydrogel only,
wherein the soluble semi-liquid hydrogel outside the irradiated selected parts is dissolved in a solvent and removed from the substrate.

10. The method of claim 1, wherein the steps of depositing the semi-liquid hydrogel and irradiating the semi-liquid hydrogel include
3D-printing or jet modeling the semi-liquid hydrogel on the zinc anode, and,
directly afterwards, irradiating a plurality of portions of the semi-liquid hydrogel, that are deposited on the zinc anode, with the light simultaneously or one after the other.

11. The method of claim 1, further comprising laterally enclosing the zinc anode, the hydrogel and the air cathode by an electrically isolating border cover frame.

12. A Zn-air battery comprising
a zinc anode deposited on a substrate, the substrate being a silicon chip or a PCB;
a layer of a drop-free hydrogel on the zinc anode, the drop-free hydrogel including a polymer, that is crosslinked on-site and comprises an irradiation-activatable crosslinking initiator, and an electrolyte, and
an air cathode sticking to the drop-free hydrogel, the air cathode comprising electrically conductive carbon, a covalent organic framework and a catalyst.

13. The Zn-air battery of claim 12, wherein the electrically conductive carbon comprises CNTs, the covalent organic framework comprises porphyrin and the catalyst comprises cobalt.

14. The Zn-air battery of claim 12, wherein the polymer further comprises a crosslinker, wherein the crosslinker preferably includes N, N′-methylenebisacrylamide and the irradiation-activatable crosslinking initiator preferably includes α-ketoglutaric acid.

15. The Zn-air battery of claim 12, wherein the polymer includes at least one component selected from polyvinyl alcohols, polyacrylic amides, polyacrylic acids, sodium polyacrylates and potassium polyacrylates.

16. The Zn-air battery of claim 12, wherein the drop-free hydrogel includes
25 wt % to 30 wt % acrylic acid;
2 wt % to 3 wt % polyvinyl alcohol;
0.1 wt % to 0.3 wt % N, N′-methylenebisacrylamide;
0.3 wt % to 0.5 wt % α-ketoglutaric acid; and
15 wt % to 20 wt % NaOH.

17. The Zn-air battery of claim 12, wherein the zinc anode is connected to a current collector formed on the substrate and wherein the zinc anode, the drop-free hydrogel and the air cathode are laterally enclosed by an electrically isolating border cover frame.

18. The Zn-air battery of claim 17, wherein the air cathode is electrically contacted to a conductor path formed on the substrate by an electric conductor arranged in or on the border cover frame.

19. The Zn-air battery of claim 12, wherein lateral dimensions of the zinc anode, the layer of the drop-free hydrogel and the air cathode are in a range from 1 to 10 mm, and a stack thickness of the zinc anode, the layer of the drop-free hydrogel and the air cathode is in a range from 1 to 6 mm.

20. The Zn-air battery of claim 12, wherein at least one other device is mounted on the substrate that is electrically connected to the Zn-air battery.
